(19) United States
(12) Patent Application Publication
(10) Pub. No.: US 2021/0123765 A1
(43) Pub. Date: Apr. 29, 2021

(54) PASTIME PREFERENCE ESTIMATION DEVICE AND PASTIME PREFERENCE ESTIMATION METHOD

(71) Applicant: NTT DOCOMO, INC., Chiyoda-ku (JP)

(72) Inventors: Takeshi KAMIYAMA, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/042,687

(22) PCT Filed: Jan. 16, 2019
(86) PCT No.: PCT/JP2019/001121

§ 371 Date: Sep. 28, 2020

(30) Foreign Application Priority Data
Apr. 18, 2018 (JP) 2018-079823

(51) Int. Cl. G01C 21/36; G01C 21/34

(52) U.S. Cl. CPC G01C 21/3617; G01C 21/3682; G01C 21/3476

(57) ABSTRACT

A pastime preference estimation device includes: a history acquiring unit configured to acquire visit history data in a predetermined period including visiting POI candidates and categories of the visiting POI candidates; a distribution information acquiring unit configured to acquire information on a distribution of the categories of the visiting POI candidates on the basis of the acquired visit history data; and a pastime preference estimating unit configured to estimate a pastime preference of a user on the basis of acquisition information including at least the acquired information on the distribution of the categories of the visiting POI candidates.

### TECHNICAL FIELD

The invention relates to a pastime preference estimation device and a pastime preference estimation method for estimating a pastime preference of a user.

### BACKGROUND ART

A technique of storing positions of facilities (points of interest (hereinafter referred to as POIs)) which can be visiting destinations of a user, acquiring position information indicating a position of the user, estimating a visiting POI which is a visiting destination of the user on the basis of a relationship between a stationary position of the user indicated by the position information and a position of a POI (for example, a distance therebetween), and estimating a pastime preference of the user on the basis of the acquired visiting POI is known.

In such a technique, when a user visits an area in which a plurality of facilities (POIs) are concentrated, a commercial complex including a plurality of facilities (POIs), or the like, it is difficult to appropriately narrow visiting POIs. Accordingly, measures of excluding a result of estimation of a visiting POI which is acquired when narrowing is difficult, for example, from basis information for estimating a pastime preference of the user are taken.

### CITATION LIST

### Patent Literature

[Patent Literature 1] Japanese Patent Application Publication No. 2005-127854

### SUMMARY OF INVENTION

### Technical Problem

However, since there can actually be cases in which a user visits an area in which a plurality of facilities (POIs) are concentrated, a commercial complex including a plurality of facilities (POIs), or the like (see Patent Literature 1), accurate estimation of a pastime preference of a user is restricted in the method according to the related art in which a result of estimation of a visiting POI when narrowing is difficult is simply excluded from basis information for estimating a pastime preference. On the other hand, since it is understood that there is a relatively high probability of a visit to a visiting POI (hereinafter referred to as a “visit probability”) when narrowing of visiting POIs is not difficult and visiting POIs are satisfactorily narrowed, or the like, measures of increasing estimation accuracy of a pastime preference by regarding a result of estimation of visiting POIs with a relatively high visit probability as important are expected.

Therefore, an objective of the invention is to more accurately estimate a pastime preference of a user.

### Solution to Problem

A pastime preference estimation device according to an embodiment of the invention includes: a history acquiring unit configured to acquire visit history data in a predetermined period including visiting POI candidates and categories of the visiting POI candidates; a distribution information acquiring unit configured to acquire information on a distribution of the categories of the visiting POI candidates on the basis of the visit history data acquired by the history acquiring unit; and a pastime preference estimating unit configured to estimate a pastime preference of a user on the basis of acquisition information including at least the information on the distribution of the categories of the visiting POI candidates acquired by the distribution information acquiring unit.

In the pastime preference estimation device, the history acquiring unit acquires visit history data in a predetermined period including visiting POI candidates and categories of the visiting POI candidates, the distribution information acquiring unit acquires information on a distribution of the categories of the visiting POI candidates on the basis of the acquired visit history data, and the pastime preference estimating unit estimates a pastime preference of a user on the basis of acquisition information including at least the acquired information on the distribution of the categories of the visiting POI candidates. In this way, by estimating a pastime preference of a user on the basis of the acquisition information including “information on a distribution of categories of visiting POI candidates” which was not considered in the related art, it is possible to more accurately estimate a pastime preference of a user.

### Advantageous Effects of Invention

According to the invention, it is possible to more accurately estimate a pastime preference of a user.

### BRIEF DESCRIPTION OF DRAWINGS

FIG. 1 is a functional block diagram illustrating a pastime preference estimation device according to first and second embodiments of the invention.

FIG. 2 is a diagram schematically illustrating a visit history table.

FIG. 3 is a flowchart illustrating process A according to the first embodiment.

FIG. 4 is a diagram illustrating a category distribution of candidates for a visiting POI.

FIG. 5 is a flowchart illustrating process B according to the first embodiment.

FIG. 6 is a diagram illustrating the process B in detail.

FIG. 7 is a flowchart illustrating process C according to the second embodiment.

FIG. 8 is a flowchart illustrating process D according to the second embodiment.

FIG. 9 is a diagram illustrating an example of a hardware configuration of the pastime preference estimation device.

### DESCRIPTION OF EMBODIMENTS

Hereinafter, various embodiments of the invention will be described with reference to the accompanying drawings. In the following description, an embodiment in which a result of estimation of a visiting POI (unspecified visiting POIs) when it is difficult to narrow visiting POIs is used as basis information for estimating a pastime preference will be described as a first embodiment, and an embodiment in which estimation of a pastime preference is performed by regarding a result of estimation of a visit POI with a relatively high probability of a visit to a visiting POI (a visit probability) as important will be described as a second embodiment.

[Configuration of Pastime Preference Estimation Device]

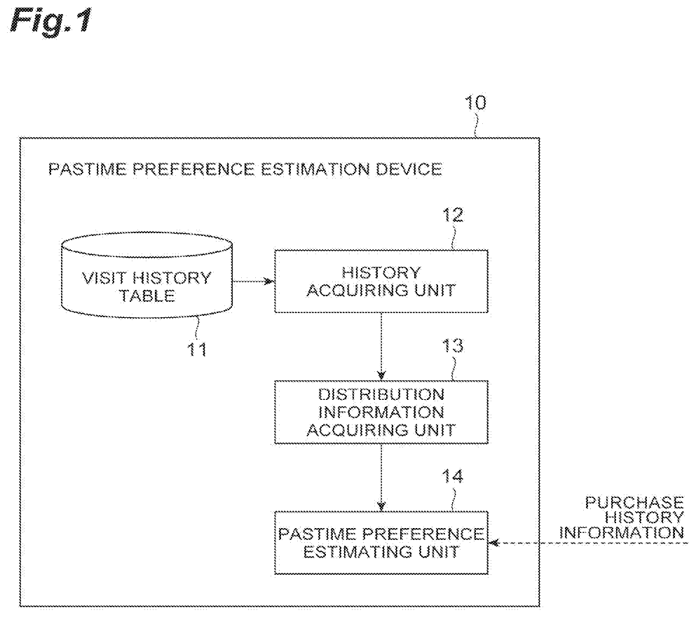

The configuration of a pastime preference estimation device is almost the same between the first and second embodiments, and thus this configuration will be described first below. As illustrated in FIG. 1, a pastime preference estimation device 10 includes a visit history table 11, a history acquiring unit 12, a distribution information acquiring unit 13, and a pastime preference estimating unit 14.

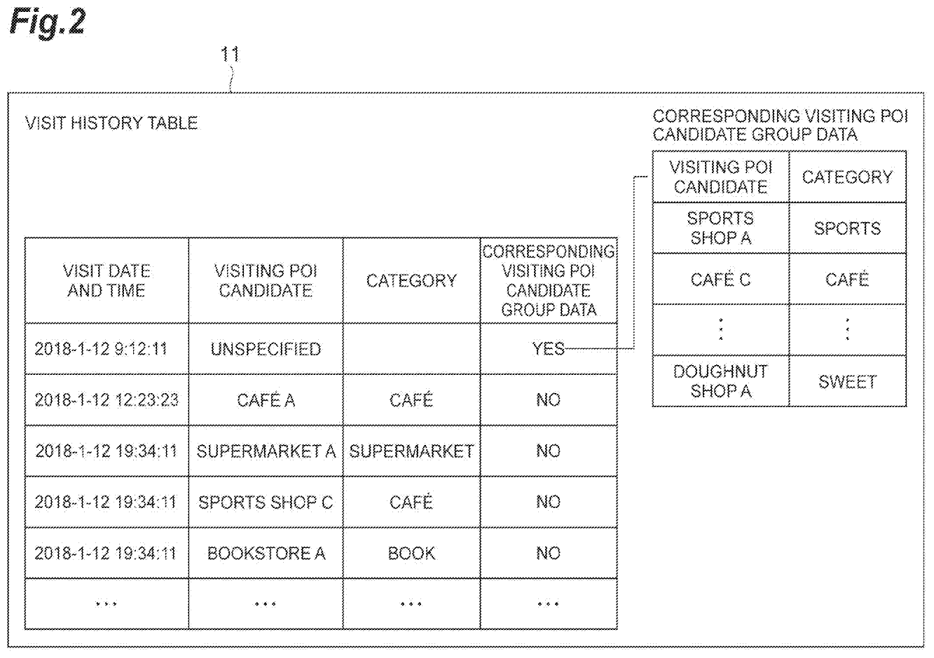

For example, as illustrated in FIG. 2, at least a visit date and time, a visiting POI candidate, a category of the visiting POI candidate, and a flag indicating whether there is corresponding visit POI candidate group data are stored in the visit history table 11. When the visiting POI candidate is “unspecified” in FIG. 2, it indicates, for example, a situation in which a user visits an area in which a plurality of facilities (POIs) are concentrated, a commercial complex including a plurality of facilities (POIs), or the like and a visiting POT candidate cannot be specified. When the visiting POI candidate is “unspecified” in this way, “YES” of the corresponding visiting POI candidate group data is stored in correlation with the corresponding visiting POI candidate group data. An example of the corresponding visiting POI candidate group data is information in which POIs (visiting POI candidates) associated with a POI-concentrated area, a commercial complex, or the like which a user is estimated to visit are correlated with categories thereof.

The history acquiring unit 12 is a functional unit that acquires visit history data in a predetermined period including visiting POI candidates and categories of the visiting POI candidates from the visit history table 11.

The distribution information acquiring unit 13 is a functional unit that acquires information on a distribution of the categories of the visiting POI candidates on the basis of the visit history data acquired by the history acquiring unit 12.

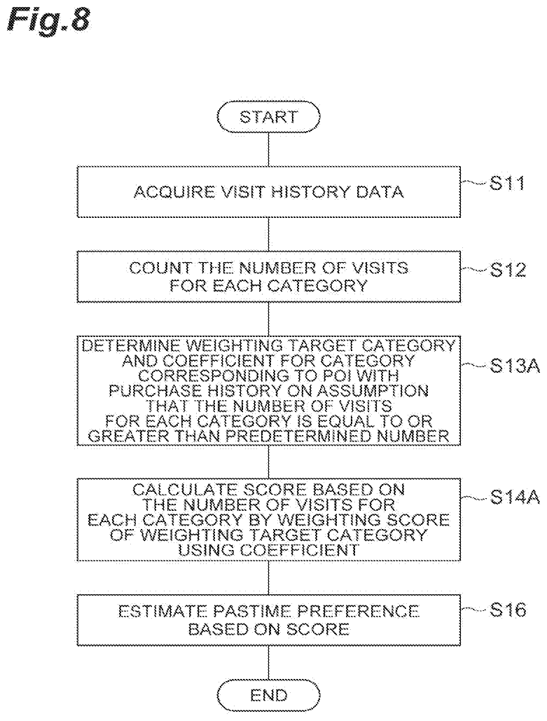

The pastime preference estimating unit 14 is a functional unit that estimates a pastime preference of a user on the basis of acquisition information including at least the information on the distribution of categories of the visiting POI candidates acquired by the distribution information acquiring unit 13. A process of estimating a pastime preference which is performed by the pastime preference estimating unit 14 can employ various aspects which will be described later. For example, in the process D (FIG. 8) according to the second embodiment which will be described later, processes in which the pastime preference estimating unit 14 acquires purchase history information of a user from the outside and estimates a pastime preference of the user on the additional basis of the purchase history information will be described.

The pastime preference estimation device 10 does not have to include the visit history table 11, and the visit history table 11 may be provided outside the pastime preference estimation device 10 and transmit and receive information to and from the pastime preference estimation device 10.

### First Embodiment

Hereinafter, an embodiment in which a result of estimation of a visiting POI (unspecified visiting POIs) when it is difficult to narrow visiting POIs of a target user is used as basis information for estimating a pastime preference of the target user will be described as a first embodiment. In the first embodiment, a process of estimating a pastime preference additionally using a distribution of categories of visiting POI candidates corresponding to unspecified visiting POIs when there are unspecified visiting POIs in addition to specified visiting POIs will be described as process A, and a process of estimating a pastime preference by weighting a common category in a distribution of a plurality of groups of categories corresponding to a plurality of unspecified visiting POIs will be described as process B.

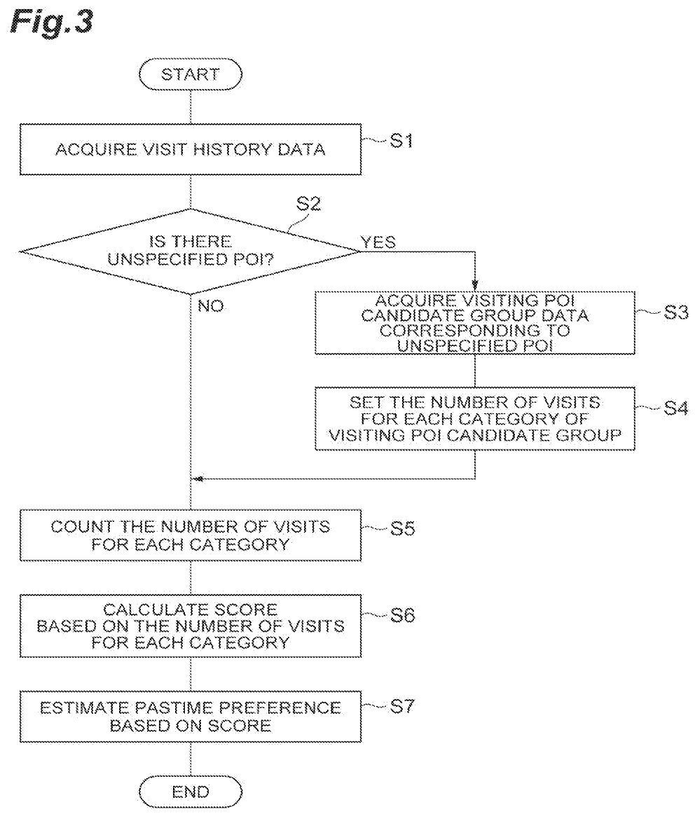

In the process A, as illustrated in FIG. 3, the history acquiring unit 12 acquires visit history data in a predetermined period including visiting POI candidates of a target user and categories of the visiting POI candidates from the visit history table 11 (Step S1). The acquired visit history data is transmitted to the distribution information acquiring unit 13.

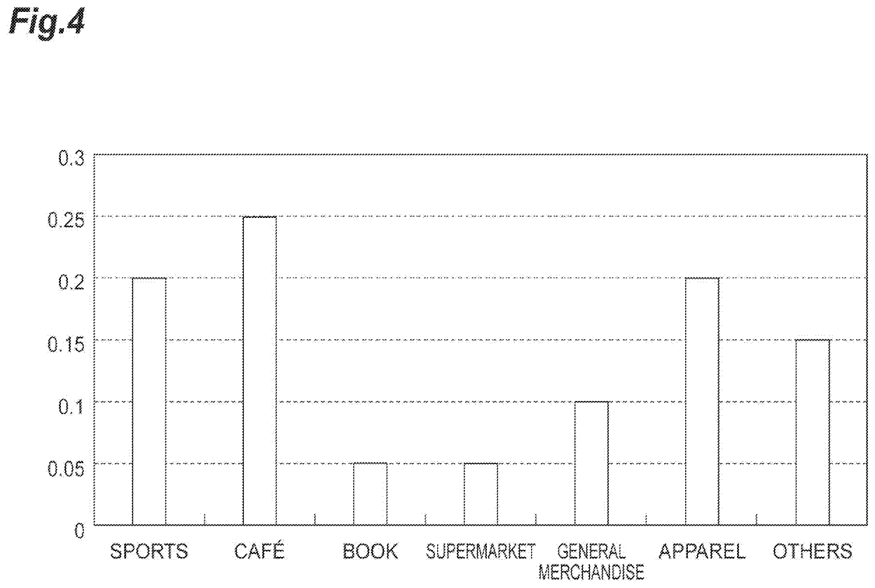

Then, the distribution information acquiring unit 13 determines whether there is an unspecified visiting POI in the visit history data (Step S2) and acquires visiting POI candidate group data corresponding to the unspecified visiting POI from the visit history table 11 when there is the unspecified visiting POI (Step S3). Then, the distribution information acquiring unit 13 sets the number of visits for each category in the visiting POI candidate group data (Step S4). For example, FIG. 4 illustrates certain visiting POI candidate group data and specifically illustrates a distribution of categories of a plurality of visiting POI candidates (for example, a plurality of tenants occupying a certain commercial complex). In FIG. 4, for example, visiting POI candidates are classified into a total of seven categories such as sports, café, books, supermarket, general merchandise, apparel, and others, and a result obtained by dividing the number for each category by the total number (that is, a ratio of each category to the total number (for example, a proportion of sports is 0.2)) is illustrated.

In Step S4, for an unspecified visiting POI, a value of a proportion of each category illustrated in FIG. 4 is set as the number of visits associated with the corresponding category. That is, for one visit in which a visiting POI candidate is “unspecified,” the numbers of visits such as the number of visits “0.2” of the category “sports” and the number of visits “0.25” of the category “café” are set in the example illustrated in FIG. 4. The setting result of Step S4 is transmitted to the pastime preference estimating unit 14.

Then, the pastime preference estimating unit 14 counts the number of visits for each category on the basis of information on the visiting POI candidates corresponding to the specified visiting POI candidates in the visit history data and information of the number of visits of the unspecified visiting POIs set in Step S4 (Step S5) and calculates an index value (referred to as a “score” in this embodiment) indicating a pastime preference strength for each type of pastime preference of each user on the basis of the number of visits for each category (Step S6). Then, the pastime preference estimating unit 14 estimates the pastime preference of the user on the basis of the calculated score for each category (Step S7). For example, a category with the highest score may be estimated as the pastime preference of the user or a category which is ranked at a predetermined position (for example, third) from the top in score may be estimated as the pastime preference of the user. The result of estimation may be output through an output device such as a display, a speaker, or a printer which is not illustrated.

Through the process A described above, visiting POI candidate group data corresponding to unspecified visiting POI candidates in the visit history data can be used to estimate a pastime preference and a pastime preference of a user can be more accurately estimated in comparison with the related art in which the unspecified visiting POI candidates are merely excluded.

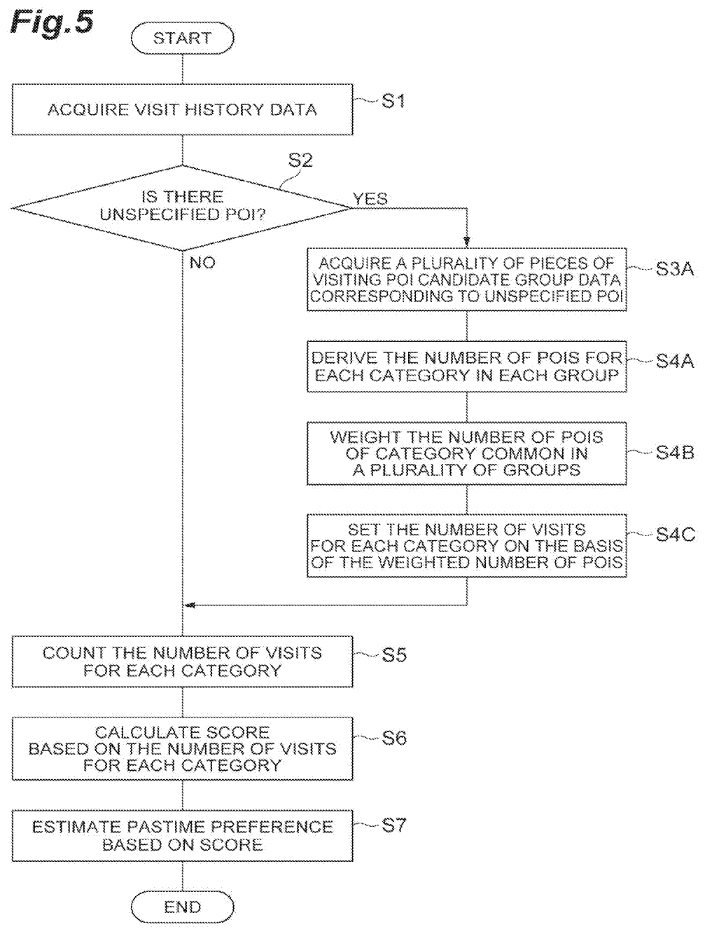

A process of estimating a pastime preference by weighting a category which is common in a distribution of a plurality of groups of categories corresponding to a plurality of unspecified visiting POI candidates will be described below as the process B according to the first embodiment. The process B is different from the process A in Steps S3A to S4C in FIG. 5 and thus these differences will be described below.

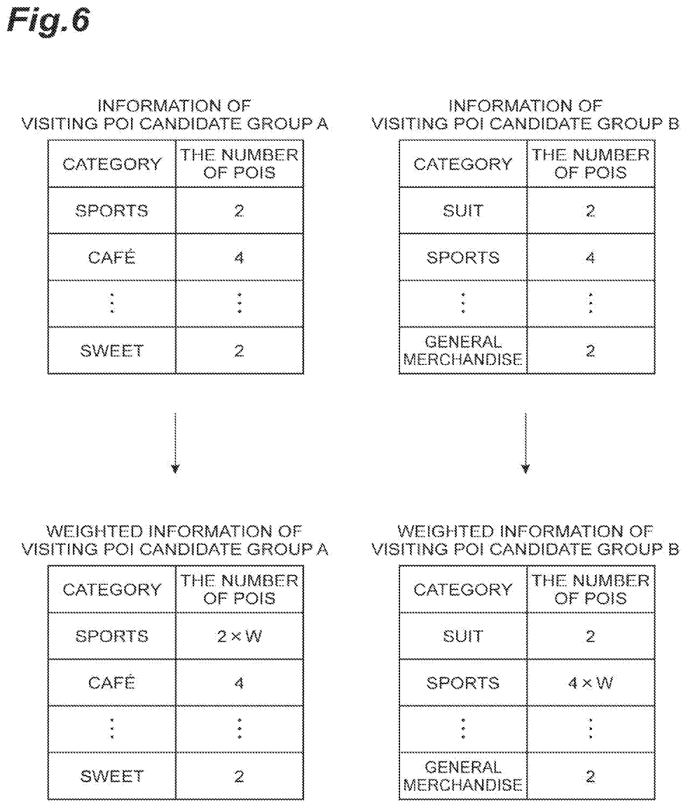

In the process B, it is determined in Step S2 that there are a plurality of unspecified visiting POI candidates in the visit history data, and the distribution information acquiring unit 13 acquires a plurality of groups of visiting POI candidate group data corresponding to the unspecified visiting POI candidates from the visit history table 11 (Step S3A). Then, the distribution information acquiring unit 13 derives the number of POIs for each category in each group (Step S4A) and weights the number of POIs of a category which is common in the plurality of groups (Step S4B). For example, an example of data of each of visiting POI candidate groups A and B is illustrated in the upper part of FIG. 6, and the category “sports” is common in visiting POI candidate groups A and B. Accordingly, in Step S4B, the number of POIs of the common category “sports” is weighted. An example of weighting which is performed by multiplying the number of POIs of the common category “sports” by a coefficient W which is greater than 1 is illustrated in the lower part of FIG. 6. The distribution information acquiring unit 13 sets the number of visits for each category on the basis of the weighted number of POIs (Step S4C).

Thereafter, similarly to the process A, the pastime preference estimating unit 14 counts the number of visits for each category on the basis of information on the visiting POI candidates corresponding to the specified visiting POI candidates in the visit history data and information of the number of visits of the unspecified visiting POIs set in Step S4C (Step S5), calculates a score on the basis of the number of visits for each category (Step S6), and estimates the pastime preference of the user on the basis of the calculated score for each category (Step S7).

Through the process B described above, the pastime preference is estimated by weighting the common category in a distribution of a plurality of groups of categories corresponding to a plurality of unspecified visiting POIs. Accordingly, it is possible to accurately estimate a pastime preference of a user by weighting the common category.

In the processes A and B according to the first embodiment, only the category distribution corresponding to the unspecified visiting POIs is used, but the invention is not limited to use of only the category distribution for the unspecified visiting POIs and other information may be considered as follows.

For example, priority of each category included in the category distribution may be evaluated on the basis of a point of view such as term frequency-inverse document frequency (TF-IDF) and the acquired priority of each category may be considered. In this case, it is possible to estimate a pastime preference of a user without an inclination to a most common category which is in any commercial facility such as “supermarket” (that is, a category with relatively low priority).

When a “visit score” for each visiting POI candidate which is an index indicating a likelihood that a visiting POI candidate is estimated to be visited can be acquired, the visit score for each visiting POI candidate may be considered in addition to the category distribution of the visiting POI candidates. For example, when proportions in the category distribution are 0.5 for sports and 0.2 for café, the visit score of sports shop A is 0.4, the visit score of sports shop B is 0.3, and the visit score of café C is 0.2, a value obtained by multiplying the proportions of the category distribution by the visit score for each category is 0.35 for sports and 0.04 for café. For example, a pastime preference of a user may be estimated on the basis of the values obtained by multiplying the proportions of the category distribution by the visit score. In this case, since the visit score for each visiting POI candidate is also considered, it is possible to more accurately estimate a pastime preference of a user.

### Second Embodiment

Hereinafter, an embodiment in which estimation of a pastime preference of a target user is performed by regarding a result of estimation of a visit POI with a relatively high probability of a visit of the target user to a visiting POI as important will be described as a second embodiment. In the second embodiment, a process of estimating a pastime preference by regarding specified visiting POI candidates when the visiting POI candidates are specified as visiting POI candidates with a relatively high visit probability and weighting a category corresponding to a specified visiting POI candidate as a weighting target category will be described as process C, and a process of estimating a pastime preference by regarding a visiting POI candidate with a user's purchase history out of visiting POI candidates as a visiting POI candidate with a relatively high visit probability and weighting a category corresponding to the specified visiting POI candidate as a weighting target category will be described as the process D.

Here, a “score” for each category may be weighted or the “number of visits” for each category which is basis information for calculating the score may be weighted. In the following description, for example, the “number of visits” for each category is weighted in the process C and the “score” for each category is weighted in the process D, but an inverted pattern thereof (that is, one in which the “score” is weighted in the process C and the “number of visits” is weighted in the process D) may be employed.

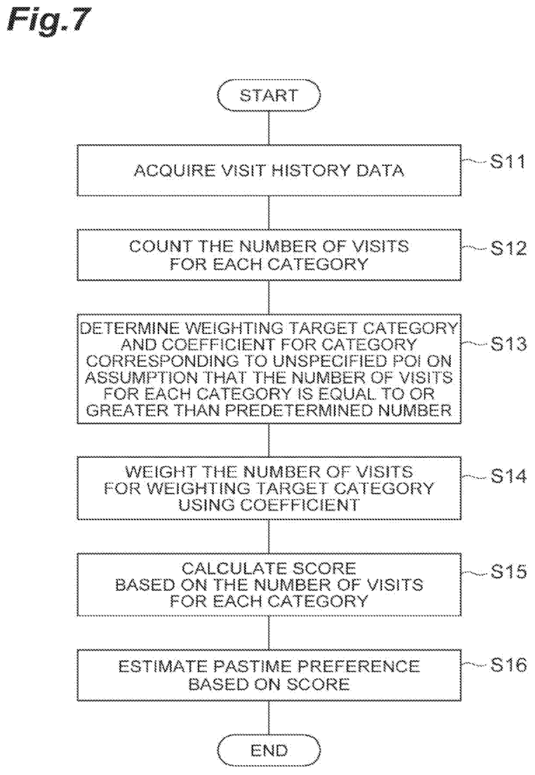

In the process C described above, as illustrated in FIG. 7, the history acquiring unit 12 acquires visit history data in a predetermined period including visiting POI candidates of a target user and categories of the visiting POI candidates from the visit history table 11 (Step S11), and the distribution information acquiring unit 13 counts the number of visits for each category, for example, on the basis of information of the visiting POI candidates corresponding to specified visiting POI candidates in the visit history data (Step S12).

Then, the pastime preference estimating unit 14 determines a category in which the number of visits for each category is equal to or greater than a predetermined number out of the categories corresponding to the specified visiting POI candidates in the visit history data as a weighting target category and additionally determines a coefficient which is used for the weighting (Step S13). For example, the “coefficient” may be a constant value which is common in the categories or may be a value which varies depending on the number of visits.

Then, the pastime preference estimating unit 14 weights the number of visits for the weighting target category using the coefficient determined in Step S13 (Step S14). For example, the number of visits may be multiplied by the coefficient, the coefficient may be added to the number of visits, or other calculation may be used.

Then, the pastime preference estimating unit 14 calculates a score based on the number of visits for each category (Step S15) and estimates the pastime preference of the user on the basis of the calculated score for each category (Step S16). For example, a category with the highest score may be estimated as the pastime preference of the user or a category which is ranked at a predetermined position (for example, third) from the top in score may be estimated as the pastime preference of the user. The result of estimation may be output through an output device such as a display, a speaker, or a printer which is not illustrated.

Through the process C described above, it is possible to more accurately estimate a pastime preference of a user through appropriate weighting based on a visit probability by weighting a category of visiting POI candidates of which a visit probability is considered to be relatively high (specified visiting POI candidates).

A process of considering a visiting POI candidate to be a visiting POI candidate with a relatively high visit probability when a user's purchase history is in the visiting POI candidate, weighting a category corresponding to the specified visiting POI candidate as a weighting target category, and estimating a pastime preference of the user will be described below as the process D according to the second embodiment. The process D is different from the process C in Steps S13A to S14A in FIG. 8 and thus these differences will be described below.

In the process D, after the number of visits for each category has been counted in Step S12, the pastime preference estimating unit 14 acquires purchase history information of a target user from the outside (for example, from an external purchase history management server), determines a category in which the number of visits for each category is equal to or greater than a predetermined number out of the categories corresponding to POIs in which there is a purchase history as a weighting target category, and determines a coefficient which is used for the weighting (Step S13A). Similarly to the process C, the “coefficient” may be a constant value which is common in the categories or may be a value which varies depending on the number of visits. The purchase history management server may be provided in the pastime preference estimation device 10.

Then, the pastime preference estimating unit 14 calculates a score based on the number of visits for each category, and calculates a score by weighting the weighting target category using the coefficient determined in Step S13A (Step S14A). Similarly to the process C, the pastime preference estimating unit 14 estimates the pastime preference of the user on the basis of the calculated score for each category (Step S16).

Through the process D described above, it is possible to more accurately estimate a pastime preference of a target user by appropriate weighting based on a visit probability by weighting the category of visiting POI candidates of which a visit probability is considered to be relatively high (visiting POI candidates in which there is a purchase history of the target user).

In the above-mentioned embodiments of the invention, the first embodiment in which the unspecified visiting POIs are used as basis information for estimating a pastime preference and the second embodiment in which a pastime preference is estimated by regarding the result of estimation of a visiting POI with a relatively high visit probability as important have been described separately described, but a combined embodiment thereof, that is, an embodiment in which the unspecified visiting POIs are used as basis information for estimating a pastime preference and a pastime preference is estimated by regarding the result of estimation of a visiting POI with a relatively high visit probability as important, may be employed.

The block diagram which is used above for description of the embodiment illustrates blocks of functional units. Such functional blocks (functional units) are realized by an arbitrary combination of hardware and/or software. A means for realizing each functional block is not particularly limited. That is, each functional block may be realized by a single device which is physically and/or logically combined or may be realized by two or more devices which are physically and/or logically separated and which are directly and/or indirectly linked to each other (for example, in a wired and/or wireless manner).

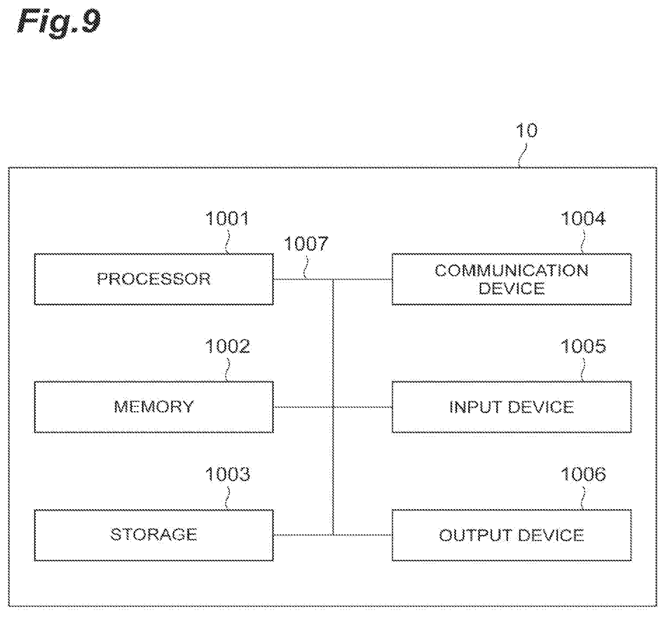

For example, the pastime preference estimation device 10 according to the embodiment may serve as a computer that performs the processes of the pastime preference estimation device 10. FIG. 9 is a diagram illustrating an example of a hardware configuration of the pastime preference estimation device 10. The pastime preference estimation device 10 may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware of the pastime preference estimation device 10 may be configured to include one or more devices illustrated in the drawing or may be configured to exclude some devices thereof.

The functions of the pastime preference estimation device 10 can be realized by reading predetermined software (program) to the hardware such as the processor 1001 and the memory 1002 and causing the processor 1001 to execute arithmetic operations and to control communication using the communication device 1004 and reading and/or writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the functional units of the pastime preference estimation device 10 may be additionally realized by the processor 1001.

The processor 1001 reads a program (a program code), a software module, or data from the storage 1003 and/or the communication device 1004 to the memory 1002 and performs various processes in accordance therewith. As the program, a program that causes a computer to perform at least some of the operations described in the above-mentioned embodiment is used. For example, the functional units of the pastime preference estimation device 10 may be realized by a control program which is stored in the memory 1002 and which operates in the processor 1001, and the other functional blocks may be realized in the same way. The various processes described above are described as being performed by a single processor 1001, but they may be simultaneously or sequentially performed by two or more processors 1001. The processor 1001 may be mounted as one or more chips. The program may be transmitted from a network via an electrical telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RANI). The memory 1002 may be referred to as a register, a cache, a main memory (a main storage device), or the like. The memory 1002 can store a program (a program code), a software module, and the like that can be executed to perform the method according to one embodiment of the invention.

The storage 1003 is a computer-readable recording medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage mediums may be, for example, a database, a server, or another appropriate medium including the memory 1002 and/or the storage 1003.

The communication device 1004 is hardware (a transmission and reception device) that performs communication between computers via a wired and/or wireless network and is also referred to as, for example, a network device, a network controller, a network card, or a communication module. For example, the functional units of the pastime preference estimation device 10 may be realized by the communication device 1004 in addition.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The pastime preference estimation device 10 may be configured to include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be mounted as at least one piece of hardware.

While an embodiment of the invention has been described above in detail, it will be apparent to those skilled in the art that the invention is not limited to the embodiment described in this specification. The invention can be altered and modified in various forms without departing from the gist and scope of the invention defined by description in the appended claims. Accordingly, the description in this specification is for exemplary explanation and does not have any restrictive meaning for the invention.

The order of processing sequences, sequences, flowcharts, and the like of the aspects/embodiments described above in this specification may be changed as long as no technical contradictions arise. For example, in the method described in this specification, various steps are described as elements of an exemplary sequence, but the method is not limited to the described sequence.

Information or the like which is input and output may be stored in a specific place (for example, a memory) or may be managed in a management table. The information or the like which is input and output may be overwritten, updated, or added. The information or the like which is output may be deleted. The information or the like which is input may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in this specification may be used alone, may be used in combination, or may be switched during implementation thereof. Transmission of predetermined information (for example, transmission of “X”) is not limited to explicit transmission, and may be performed by implicit transmission (for example, the predetermined information is not transmitted).

Regardless of whether it is called software, firmware, middleware, microcode, hardware description language, or another name, software can be widely construed to refer to commands, a command set, codes, code segments, program codes, a program, a sub program, a software module, an application, a software application, a software package, a routine, a sub routine, an object, an executable file, an execution thread, a sequence, a function, or the like.

Software, commands, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology is included in the definition of the transmission medium.

Information, signals, and the like described in this specification may be expressed using one of various different techniques. For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

Information, parameters, and the like which are described in this specification may be expressed by absolute values, may be expressed by values relative to a predetermined value, or may be expressed by other corresponding information.

A mobile communication terminal may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

The term, “determining” or “determination,” which is used in this specification may include various types of operations. The term, “determining” or “determination,” may include cases in which judging, calculating, computing, processing, deriving, investigating, looking up (for example, looking up in a table, a database, or another data structure), and ascertaining are considered to be “determined.” The term, “determining” or “determination,” may include cases in which receiving (for example, receiving information), transmitting (for example, transmitting information), input, output, and accessing (for example, accessing data in a memory) are considered to be “determined.” The term, “determining” or “determination,” may include cases in which resolving, selecting, choosing, establishing, comparing, and the like are considered to be “determined.” That is, the term, “determining” or “determination,” can include cases in which a certain operation is considered to be “determined.”

The expression “on the basis of,” as used in this specification, does not mean “on the basis of only” unless otherwise described. In other words, the expression “on the basis of” means both “on the basis of only” and “on the basis of at least.”

When the terms, “include,” “including,” and modifications thereof are used in this specification or the appended claims, the terms are intended to have a comprehensive meaning similar to the term “comprising.” The term “or” which is used in this specification or the claims is not intended to mean an exclusive logical sum.

In this specification, two or more of any devices may be included unless the context or technical constraints dictate that only one device is included. In the entire present disclosure, singular terms include plural referents unless the context or technical constraints dictate that a unit is singular.

### REFERENCE SIGNS LIST

10 . . . Pastime preference estimation device, 11 . . . Visiting history table, 12 . . . History acquiring unit, 13 . . . Distribution information acquiring unit, 14 . . . Pastime preference estimating unit, 1001 . . . Processor, 1002 . . . Memory, 1003 . . . Storage, 1004 . . . Communication device, 1005 . . . Input device, 1006 . . . Output device, 1007 . . . Bus

1: A pastime preference estimation device comprising circuitry configured to:
acquire visit history data in a predetermined period including visiting POI candidates and categories of the visiting POI candidates;
acquire information on a distribution of the categories of the visiting POI candidates on the basis of the acquired visit history data; and
estimate a pastime preference of a user on the basis of acquisition information including at least the acquired information on the distribution of the categories of the visiting POI candidates.

2: The pastime preference estimation device according to claim 1, wherein the circuitry is configured to acquire information on a distribution of categories of the visiting POI candidates corresponding to unspecified visiting POIs when the unspecified visiting POIs are included in the visit history data, and
wherein the circuitry is configured to estimate the pastime preference of the user on the basis of the acquisition information additionally including the acquired information on the distribution of the categories of the visiting POI candidates corresponding to the unspecified visiting POIs.

3: The pastime preference estimation device according to claim 2, wherein the circuitry is configured to estimate the pastime preference of the user by weighting a category which is common in a plurality of groups of information on the distribution of the categories of the visiting POI candidates corresponding to the unspecified visiting POIs when the plurality of groups of information on the distribution of the categories are acquired.

4: The pastime preference estimation device according to claim 1, wherein the circuitry is configured to estimate the pastime preference of the user by weighting a weighting target category which is determined on the basis of a probability of a visit to a visiting POI candidate corresponding to a category in the information on the distribution of the categories.

5: The pastime preference estimation device according to claim 4, wherein the probability of a visit is determined on the basis of whether or not there is a purchase history of the user in the corresponding visiting POI candidate.

6: A pastime preference estimation method which is performed by a pastime preference estimation device, the pastime preference estimation method comprising:
acquiring visit history data in a predetermined period including visiting POI candidates and categories of the visiting POI candidates;
acquiring information on a distribution of the categories of the visiting POI candidates on the basis of the acquired visit history data; and
estimating a pastime preference of a user on the basis of acquisition information including at least the acquired information on the distribution of the categories of the visiting POI candidates.

7: The pastime preference estimation device according to claim 2, wherein the circuitry is configured to estimate the pastime preference of the user by weighting a weighting target category which is determined on the basis of a probability of a visit to a visiting POI candidate corresponding to a category in the information on the distribution of the categories.

8: The pastime preference estimation device according to claim 7, wherein the probability of a visit is determined on the basis of whether or not there is a purchase history of the user in the corresponding visiting POI candidate.

9: The pastime preference estimation device according to claim 3, wherein the circuitry is configured to estimate the pastime preference of the user by weighting a weighting target category which is determined on the basis of a probability of a visit to a visiting POI candidate corresponding to a category in the information on the distribution of the categories.

10: The pastime preference estimation device according to claim 9, wherein the probability of a visit is determined on the basis of whether or not there is a purchase history of the user in the corresponding visiting POI candidate.
